(19) United States
(12) Patent Application Publication
(10) Pub. No.: US 2024/0024083 A1
(43) Pub. Date: Jan. 25, 2024

(54) REMOTE SKELETAL MODELING

(71) Applicant: SDC U.S. SmilePay SPV, Nashville, TN (US)

(72) Inventors: Tim Wucher, Windhoek (NA); John Dargis, Nashville, TN (US); Ryan Amelon, Nashville, TN (US)

(73) Assignee: SDC U.S. SmilePay SPV, Nashville, TN (US)

(21) Appl. No.: 17/871,602

(22) Filed: Jul. 22, 2022

(51) Int. Cl. A61C 13/00; A61C 7/00

(52) U.S. Cl. CPC A61C 13/0004; A61C 7/002

(57) ABSTRACT

Systems and methods for generating a user skeletal model are disclosed herein. A method includes receiving, by one or more processors, a digital representation of a user. The digital representation comprises at least one of a 2D image or a video. The method includes retrieving, by the one or more processors, a template skeletal model. The method includes adjusting, by the one or more processors, the template skeletal model to match a profile of the user depicted in the digital representation. The method includes generating, by the one or more processors, a user skeletal model that resembles a skeleton of the user.

### TECHNICAL FIELD

The present invention relates generally to the field of dental treatment planning, and more specifically, to systems and methods for generating a digital skeletal model.

### BACKGROUND

Orthodontic treatment is often used to reorient a patient's dentition. Monitoring and understanding how an upper and lower arch of the patient's dentition fit together and how they move relative to one another is critical for determining orthodontic treatment for the patient. In-person appointments are inconvenient and time consuming, and specialized equipment for identifying and monitoring the patient's dentition, including how the patient's upper and lower jaws including their upper and lower arches move relative to one another, can be expensive or difficult to use.

### SUMMARY

In one aspect, this disclosure is directed to a method. The method includes receiving, by one or more processors, a digital representation of a user. The digital representation comprises at least one of a 2D image or a video. The method includes retrieving, by the one or more processors, a template skeletal model. The method includes adjusting, by the one or more processors, the template skeletal model to match a profile of the user depicted in the digital representation. The method includes generating, by the one or more processors, a user skeletal model that resembles a skeleton of the user.

In one aspect, this disclosure is directed to a system. The system includes a processor and a memory coupled with the processor. The memory is configured to store instructions that, when executed by the processor, cause the processor to receive a digital representation of a user. The digital representation comprises at least one of a 2D image or a video. The instructions cause the processor to retrieve a template skeletal model. The instructions cause the processor to adjust the template skeletal model to match a profile of the user depicted in the digital representation. The instructions cause the processor to generate a user skeletal model that resembles a skeleton of the user.

In yet another aspect, this disclosure is directed to a non-transitory computer readable medium that stores instructions. The instructions, when executed by one or more processors, cause the one or more processors to receive a digital representation of a user. The digital representation comprises at least one of a 2D image or a video. The instructions cause the one or more processors to retrieve a template skeletal model. The instructions cause the one or more processors to adjust the template skeletal model to match a profile of the user depicted in the digital representation. The instructions cause the one or more processors to generate a user skeletal model that resembles a skeleton of the user.

Various other embodiments and aspects of the disclosure will become apparent based on the drawings and detailed description of the following disclosure.

### BRIEF DESCRIPTION OF THE DRAWINGS

FIG. 1 shows a schematic diagram of a system for remote skeletal modeling, according to an illustrative embodiment.

FIG. 2 shows a digital representation, according to an illustrative embodiment.

FIG. 3 shows a digital representation, according to an illustrative embodiment.

FIG. 4 shows a template skeletal model, according to an illustrative embodiment.

FIG. 5 shows a plurality of model landmarks, according to various illustrative embodiments.

FIG. 6 shows a digital representation, according to an illustrative embodiment.

FIG. 7 shows a user skeletal model, according to an illustrative embodiment.

FIG. 8A shows a 3D digital model of a dentition, according to an illustrative embodiment.

FIG. 8B shows a comparison of a 3D digital model of a dentition with a template skeletal model, according to an illustrative embodiment.

FIG. 9 shows an animated view of jaw bone movement, according to an illustrative embodiment.

FIG. 10 shows occlusal statuses, according to various illustrative embodiments.

FIG. 11 shows a diagram of a method of generating a user skeletal model, according to an illustrative embodiment.

FIG. 12A shows a diagram of a method of generating a user skeletal model, according to an illustrative embodiment.

FIG. 12B shows a diagram of a method of generating a user skeletal model, according to an illustrative embodiment.

### DETAILED DESCRIPTION

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, described herein are systems and methods for performing a dental and skeletal analysis using 2D images for orthodontic treatment planning. More specifically, the systems and methods disclosed herein combine cephalometric analysis techniques with facial 2D image analysis to determine a skeletal profile and location of the temporomandibular joint. The systems and methods may be used for purposes of determining an orthodontic treatment plan for a patient, as well as monitoring an orientation of a patient's upper and lower jaws. For example, with younger patients that are still growing, the orientation of the upper and lower jaws continue to change. Correcting or improving a person's bite may most easily be achieved when the upper and lower jaws are still growing and changing. Once growth has ceased, surgery may be the only option to make such corrections or improvements. As such, it is advantageous to continuously monitor the status of a person's bite while the person is still growing and the bite is still changing.

According to various embodiments, a computing device analyzes one or more digital representations of a patient (e.g., a 2D image, a plurality of 2D images, a video, a mesh, tabular data, etc.) to determine a bite of the patient. The bite can refer to the relative positioning between the upper jaw (the maxilla bone) and the lower jaw (the mandible bone). The digital representation may be captured before, during, or after undergoing orthodontic treatment. Based on various landmarks identified in the digital representation, the computing device can adjust a template skeletal model to match a facial profile of the patient depicted in the digital representation. For example, the computing device may obtain an initial template skeletal model and a 2D image of the patient's face. Based on the 2D image, the computing system can adjust the template skeletal model to resemble an actual skeleton of the patient. The computing system may generate a final skeletal model that resembles the actual skeleton of the patient. With the generated skeletal model, the computing system can simulate how the upper jaw and the lower jaw of the patient actually interact to identify bite and other dental information. Analysis of the bite may dictate an orthodontic treatment plan for the patient.

The technical solutions of the systems and methods disclosed herein improve the technical field of determining a skeletal profile of a patient, locating the temporomandibular joint of the patient, and monitoring a patient's bite, and devices and technology associated therewith. For example, in various embodiments, the accuracy, speed, and efficiency of determining a skeletal profile of a patient, locating the temporomandibular joint of the patient, and monitoring a patient's bite is improved. The efficiency is improved by combining template data and data that is captured by the patient instead of using data captured by a dental professional (e.g., a dental technician, a dentist or orthodontist, or other staff member) at an in-person office visit. For example, the final skeletal model can be based on a template model eliminating the need to obtain certain data associated with the specific patient. Additionally, the data associated with the patient used to generate the final skeletal model can be captured via a user device associated with the patient (e.g., a camera of a smart phone). This eliminates the need for expensive equipment such as x-rays and intraoral scanners and the need for the patient to visit a professional's office to gather the data necessary to generate the final skeletal model. The elimination of x-rays further benefits patient health by eliminating exposure to potentially harmful radiation. The speed of generating models is improved by analyzing all data that is relevant to indicate a relative position of an upper jaw and a lower jaw. Simultaneous incorporation of all relevant data from multiple sources improves and allows for more informed assessment of jaw orientation which leads to a more efficient (therefore, faster) algorithm. For example, a plurality of images may be received from a patient from different imaging angles and may be combined with template information to better govern generation of the final skeletal model. The accuracy can be improved because the system can incorporate various types of data and apply algorithms and artificial intelligence to consolidate the data into a single digital model.

Additional benefits of the disclosed systems and methods include generation and output of a final skeletal model that matches a person in the 2D images, which can be used for orthodontic treatment planning. A 3D representation of the patient's teeth and gums (which may be generated using a scanner, impression kit, or other 2D or 3D reconstruction techniques) can be combined with the final skeletal model to get a realistic digital model of the patient's dentition, including how the lower jaw interacts with and moves with respect to the upper jaw, and how the teeth of each jaw interact. The skeletal model can be further refined to accommodate poses of the mouth in any position (e.g., while opening and closing the mouth) to determine a natural path of the movement of the lower jaw relative to the upper jaw. The analysis of the patient's bite and the generation of the treatment plan based on the analysis can all be performed remotely since the 2D images used for generating the final skeletal model can be captured by any user device (e.g., a smart phone, camera, laptop, etc.) capable of capturing images and can be transmitted to the system from anywhere, can be analyzed from anywhere, and can be used to generate a treatment plan from anywhere.

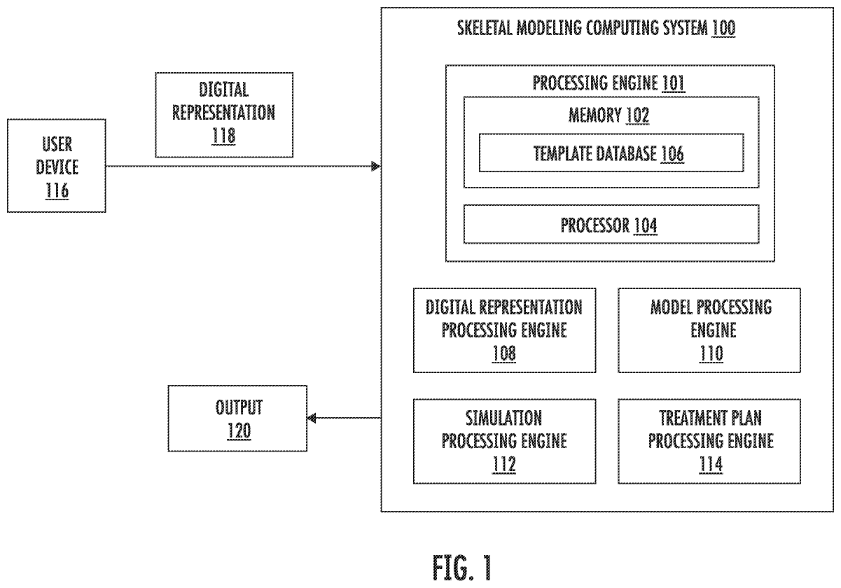

Referring to FIG. 1, a skeletal modeling computing system 100 for generating a digital representation of a patient's skeleton (e.g., skeleton of the head) is shown, according to an exemplary embodiment. The skeletal modeling computing system 100 is shown to include a processing engine 101. Processing engine 101 may include a memory 102 and a processor 104. The memory 102 (e.g., memory, memory unit, storage device) may include one or more devices (e.g., RAM, ROM, EPROM, EEPROM, optical disk storage, magnetic disk storage or other magnetic storage devices, flash memory, hard disk storage, or any other medium) for storing data and/or computer code for completing or facilitating the various processes, layers, and circuits described in the present disclosure. The memory 102 may be or include transitory memory or non-transitory memory, and may include database components, object code components, script components, or any other type of information structure for supporting the various activities and information structures described in the present disclosure. According to an illustrative embodiment, the memory 102 is communicably connected with the processor 104 and includes computer code for executing (e.g., by the processor 104) the processes described herein.

The memory 102 may include a template database 106. The template database 106 may include a plurality of template skeletal models that indicate a generic orientation of a skeleton not associated with a patient or user of the skeletal modeling computing system 100. For example, a template skeletal model may be a generic model that can be applied during orthodontic analysis of any user. In some embodiments, a template skeletal model may correspond with a user with certain characteristics (e.g., age, race, ethnicity, etc.). For example, a first template skeletal model may be associated with females and a second template skeletal model may be associated with males. In some embodiments, a first template skeletal model may be associated with a user under a predetermined age and a second template skeletal model may be associated with a user over the predetermined age. A template skeletal model may be associated with any number and any combination of user characteristics.

The processor 104 may be a general purpose single-chip or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or any conventional processor, controller, microcontroller, or state machine. The processor 104 may also be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The skeletal modeling computing system 100 may include various modules or be comprised of a system of processing engines. The processing engine 101 may be configured to implement the instructions and/or commands described herein with respect to the processing engines. The processing engines may be or include any device(s), component(s), circuit(s), or other combination of hardware components designed or implemented to receive inputs for and/or automatically generate outputs based on an initial digital representation of an intraoral device. As shown in FIG. 1, in some embodiments, the skeletal modeling computing system 100 may include a digital representation processing engine 108, a model processing engine 110, a simulation processing engine 112, and a treatment plan processing engine 114. While these engines 108-114 are shown in FIG. 1, it is noted that the skeletal modeling computing system 100 may include any number of processing engines, including additional engines which may be incorporated into, supplement, or replace one or more of the engines shown in FIG. 1.

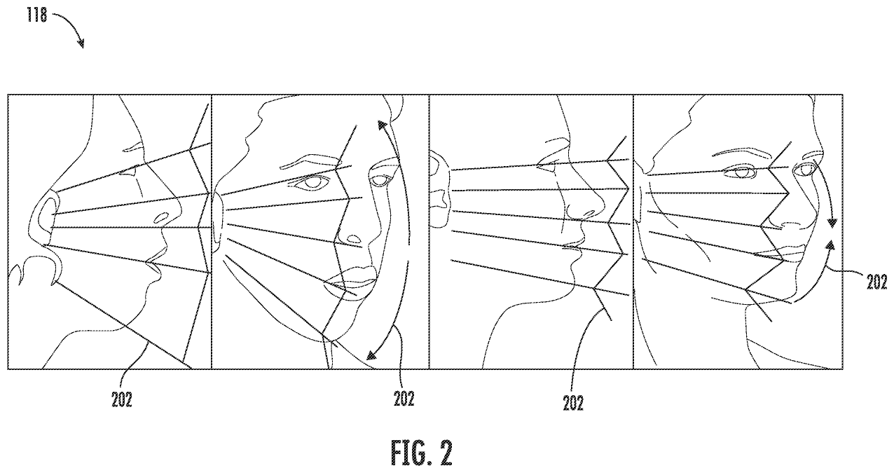

Referring now to FIGS. 1 and 2, skeletal modeling computing system 100 may be configured to receive at least one digital representation 118 of a user. For example, digital representation processing engine 108 of the skeletal modeling computing system 100 may be configured to receive at least one digital representation 118 of a user. The digital representation 118 may include data corresponding to a user (e.g., a patient), and specifically a user's face and/or head. For example, the digital representation 118 may be a 2D image, a video, a mesh, tabular data, or population-level information about most probable skeletal features, among others. The 2D image and video may be captured by any device capable of capturing images and videos (e.g., a smart phone). The tabular data may include, for example, a patient's subjective assessment of their facial features.

In some embodiments, the digital representation processing engine 108 may receive a plurality of digital representations 118. The plurality of digital representations 118 may include at least one of a plurality of individually taken images or a video. For example, the digital representation processing engine 108 may receive a plurality of 2D images. In some embodiments, the plurality of digital representations 118 may include images of the user from different perspectives. For example, a first digital representation 118 may be a 2D image of a front view of the user and a second digital representation 118 may be a 2D image of a side view of the user. In some embodiments, the plurality of digital representations 118 may include images of the user with a plurality of different expressions. For example, a first 2D image may include the user with a closed mouth, a second 2D image may include the user with a smile, and a third 2D image may include the user with an open mouth. The different expressions can indicate different positions of the user's skeleton or jaw bones. For example, the closed mouth can indicate the jaw bones are in a mouth-closed orientation and the open mouth can indicate the jaw bones are in a mouth-open orientation.

A video can provide the same visual data as the 2D images as well as audio data. For example, a video can capture audible sounds made by a patient's jaw (e.g., clicking when the patient opens or closes their mouth). A video can also capture intentional sounds made by the patient that are indicative of known positions of the patient's jaw (e.g., an “ah” sound).

In some embodiments, the skeletal modeling computing system 100 may be configured to identify a characteristic 202 of the user. The characteristic 202 may be, for example, age, gender, race, or face shape, among others. The skeletal modeling computing system 100 may be configured to identify the characteristic from the digital representation. For example, the skeletal modeling computing system 100 may identify whether the user is a male or female based on the size, shape, or contours of the face shown in the digital representation. In some embodiments, the skeletal modeling computing system 100 may receive input regarding the characteristics. For example, a user may provide an age and ethnicity associated with the user. The skeletal modeling computing system 100 may identify a plurality of characteristics associated with a single user. The characteristic(s) may facilitate selection of a template skeletal model from the template database 106.

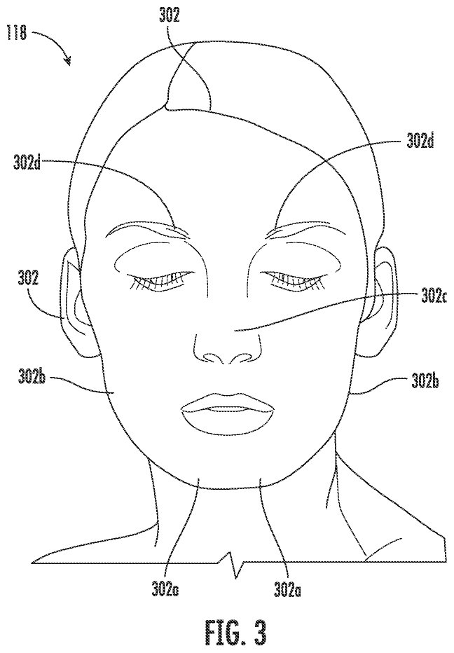

Referring to FIGS. 1 and 3, the digital representation processing engine 108 may be configured to identify landmarks, shown as user landmarks 302, based on the digital representations 118. The user landmarks 302 may be associated with the profile of the user captured in the digital representation 118. The user landmarks 302 can be based off of the soft tissue features captured in the digital representation 118. User landmarks 302 may include, for example, a chin user landmark 302a, a jaw user landmark 302b, a nose user landmark 302c, or an eye user landmark 302d. The digital representation processing engine 108 may identify any number of user landmarks 302 in the digital representation 118. The user landmarks 302 may include different types of landmarks such as, for example, specific points, areas, contours, orientations, or any other feature identifiable in the digital representation 118. The digital representation processing engine 108 may compare the user landmarks 302 to corresponding landmarks of a template skeletal model. The digital representation processing engine 108 may identify user landmarks 302 in a plurality of digital representations 118. The digital representation processing engine 108 may identify the same user landmarks 302 in each of the digital representations 118. In some embodiments, the digital representation processing engine 108 may identify different user landmarks 302 in the different digital representations 118. For example, a first representation may be captured at a first orientation such that only the right side of the user's head is depicted and a second digital representation 118 may be captured at a second orientation such that only the left side of the user's head is depicted such that the digital representation processing engine 108 identifies a first set of user landmarks from the first digital representation 118 and a second set of user landmarks from the second digital representation 118.

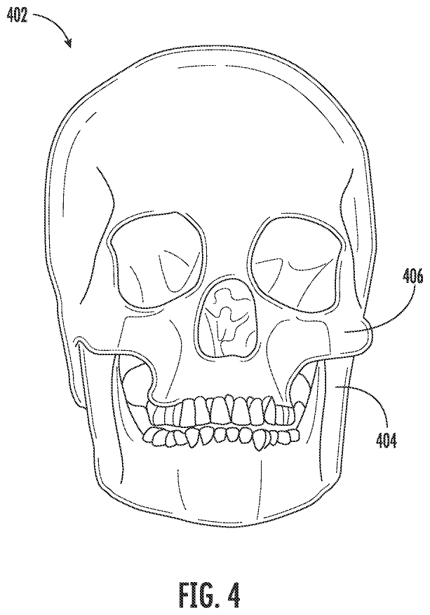

Referring to FIGS. 1, 4, and 5, the skeletal modeling computing system 100 may be configured to retrieve a template skeletal model 402. For example, the model processing engine 110 may be configured to retrieve a template skeletal model 402. The template skeletal model 402 can include a lower jaw 404 and an upper jaw 406, among other parts. The template skeletal model 402 may include 3D geometries as shown in FIG. 4. The template skeletal model may also consist of only a wire frame consisting of individual points or lines and have no 3D geometries. The template skeletal model 402 may consist of one or more model landmarks 502. The model landmarks 502 may be sufficient to describe the skeletal model 402. The template skeletal model 402 may include a wire frame including individual points, lines, or landmarks, but have no 3D geometries. The template skeletal model 402 may be retrieved from the template database 106. The template database 106 may optionally include a plurality of template skeletal models 402. For example, the template database 106 may have different template skeletal models 402 that correspond with certain characteristics 202. For example, a first template skeletal model 402 may correspond to a certain age group and a second template skeletal model 402 may correspond to a certain gender. For example, the first template skeletal model 402 may correspond with users with ages between 0-18 and the second template skeletal model 402 may correspond with females. A template skeletal model 402 may correspond with a plurality of characteristics 202. For example, a third template skeletal model 402 may correspond to both a certain age group and a certain gender. For example, the third template skeletal model 402 may correspond with males that are older than 18 years old. The template skeletal model 402 may also be a generic skeletal model (e.g., not associated with any specific characteristics) that can be used in any case regardless of patient characteristics (e.g., age, gender, ethnicity, etc.). For example, the template skeletal model 402 may be based on population data that can be used for anyone regardless of their patient characteristics.

To retrieve the template skeletal model 402, the model processing engine 110 may be configured to select one of the plurality of template skeletal models 402 from the template database 106. The selection may be based on the identified characteristics 202 of the user from the digital representations 118. For example the template skeletal model 402 may be based on at least one of an age, gender, race, or facial feature of the user. The model processing engine 110 may select a template skeletal model 402 that corresponds with the same characteristics 202 that were identified from the digital representation 118. For example, when the skeletal modeling computing system 100 determines the user depicted in the digital representation 118 is a female and is over the age of 18, the model processing engine 110 may select a template skeletal model 402 that corresponds with the characteristics 202 of female and over the age of 18.

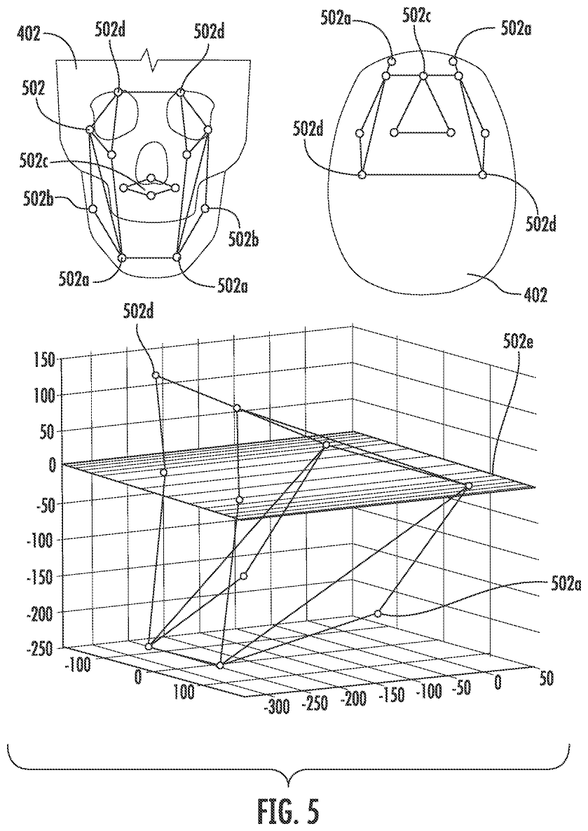

The skeletal modeling computing system 100 may be configured to identify a landmark of the template skeletal model 402, shown as model landmark 502. For example, the model processing engine 110 may be configured to identify a landmark of the template skeletal model 402. The model processing engine 110 may be configured to identify a plurality of model landmarks 502 associated with the template skeletal model 402. The template skeletal model 402 may include any or all landmarks found in conventional cephalometric analysis. For example, the template skeletal model 402 can include a reference plane, a geometry axis of movement, or a soft tissue feature. The model landmarks 502 can be the same as the user landmarks 302 identified in the digital representations 118. For example, the digital representation processing engine 108 may identify user landmarks 302a-302d and the model processing engine 110 may identify a chin model landmark 502a, a jaw model landmark 502b, a nose model landmark 502c, or an eye model landmark 502d. Each of the plurality of model landmarks 502 may have a corresponding user landmark 302. Each of the plurality of model landmarks 502 may be a point, a line, a curve, a plane, or any other geometric shape (e.g., any 2D or 3D geometry). For example, a chin model landmark 502a may be one or more points as shown in FIG. 5. In another embodiment, a chin model landmark 502a may be a 3D surface of a chin. The 3D chin model landmark 502a may have a corresponding chin user landmark 302a which can be identified in the digital representation 118. The same can be applied to any feature of a user.

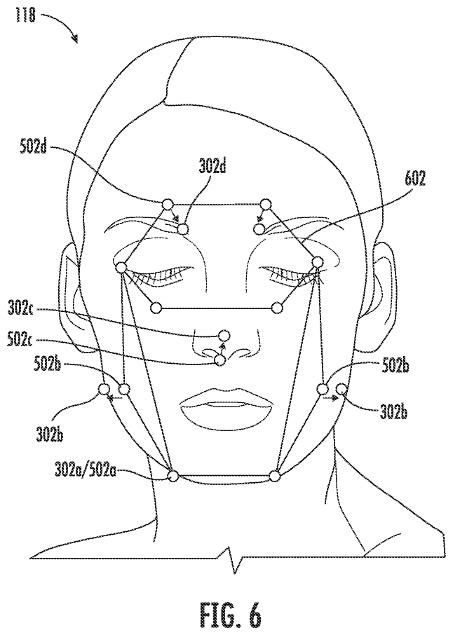

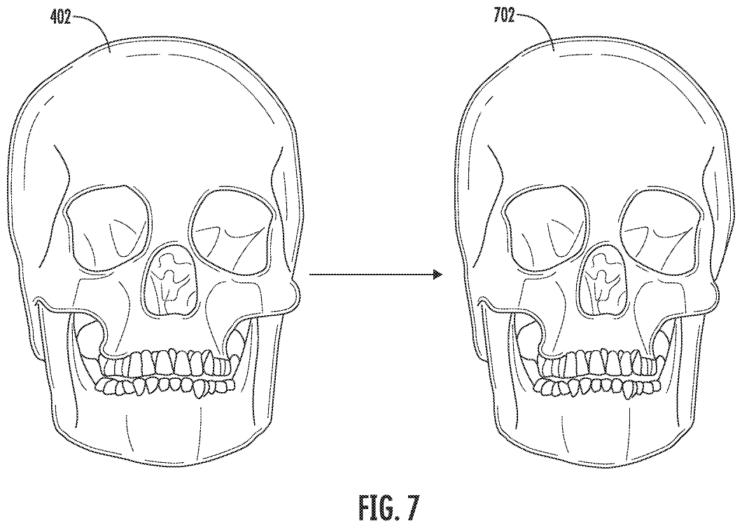

Referring to FIGS. 1, 6, and 7, the skeletal modeling computing system 100 may be configured to adjust the template skeletal model 402. For example, the model processing engine 110 may be configured to adjust the template skeletal model 402. Adjusting the template skeletal model 402 can generate a second, or final skeletal model, shown as user skeletal model 702, along with various intermediate skeletal models. For example, the model processing engine 110 may be configured to adjust the template skeletal model 402 to match a profile of the user from a digital representation 118. To match the profile, the model processing engine 110 can compare the model landmarks 502 with the user landmarks 302. For example, the model processing engine 110 can overlay a projection 602 of the template skeletal model 402 (e.g., the model landmarks 502) with the digital representation 118. The model processing engine 110 can compare a location of a model landmark 502 with a corresponding user landmark 302 and adjust the template skeletal model 402 until the corresponding landmarks 302, 502 are aligned. The model landmarks 502 and the user landmarks 302 can be any type of landmark including, for example, points, lines, planes, 2D geometries, and 3D geometries, among others. The model processing engine 110 may adjust a plurality of model landmarks 502 to match positions of respective corresponding user landmarks 302. Such adjustments can cause the template skeletal model 402 to create a user skeletal model 702 that resembles an actual skeleton of the user. The model processing engine 110 may be configured to iteratively adjust the template skeletal model 402. For example, the skeletal modeling computing system 100 may receive a plurality of 2D images. The model processing engine 110 may iteratively adjust the template skeletal model 402 to match the profile and skeletal features of the user based on the plurality of 2D images. The model processing engine 110 may continue to adjust the template skeletal model 402 until each digital representation 118 is considered. In some embodiments, the model processing engine 110 may only consider a subset of the plurality of digital representations 118 received.

In some embodiments, the model processing engine 110 adjusts the template skeletal model 402 first based on a first particular landmark (e.g., a nose user landmark 302c) before adjusting the template skeletal model 402 based on a second particular landmark (e.g., a chin user landmark 302a). It will be appreciated that the order of particular landmarks used may be any order of any of the landmarks disclosed herein or known in the art. In some embodiments, the model processing engine 110 adjusts the template skeletal model 402 based on the first particular landmark for a threshold number of iterations (e.g., 1 iteration, 2 iterations, 5 iterations, 10 iterations, etc.) before adjusting the template skeletal model 402 based on the second particular landmark. In some embodiments, the model processing engine 110 adjusts the template skeletal model 402 using a particular order of landmarks based on a quality of the digitation representations received. For example, the model processing engine 110 can adjust the template skeletal model 402 first based on a jaw user landmark 302b based on an image quality score associated with a digital representation 118 showing the jaw user landmark 302b exceeding an image quality score threshold, and then adjust the template skeletal model 402 based on a chin user landmark 302a, or other user landmark. In another embodiment the model processing engine 110 can adjust the template skeletal model 402 while considering each landmark simultaneously and adjusting the template skeletal model 402 to increasingly represent the digital representation 118 of the user. The model processing engine 110 may also assign different weighting to each landmark to ensure a better correspondence of certain landmarks that are stronger or are considered more important for determining the user skeletal model 702.

The skeletal modeling computing system 100 may be configured to generate the user skeletal model 702. For example, the model processing engine 110 may be configured to generate a user skeletal model. The user skeletal model may resemble or match a skeleton of the user in the digital representation 118. For example, the adjustments based on the landmarks 302, 502 may cause the template skeletal model 402, or portions thereof, to become reoriented to closer resemble a skeleton of the user. For example, when the digital representation 118 shows a narrower chin than is included in the template skeletal model 402, the user skeletal model may have a narrower chin than the template skeletal model 402. Any feature of the template skeletal model 402 can be altered such that the user skeletal model resembles the skeleton of the user.

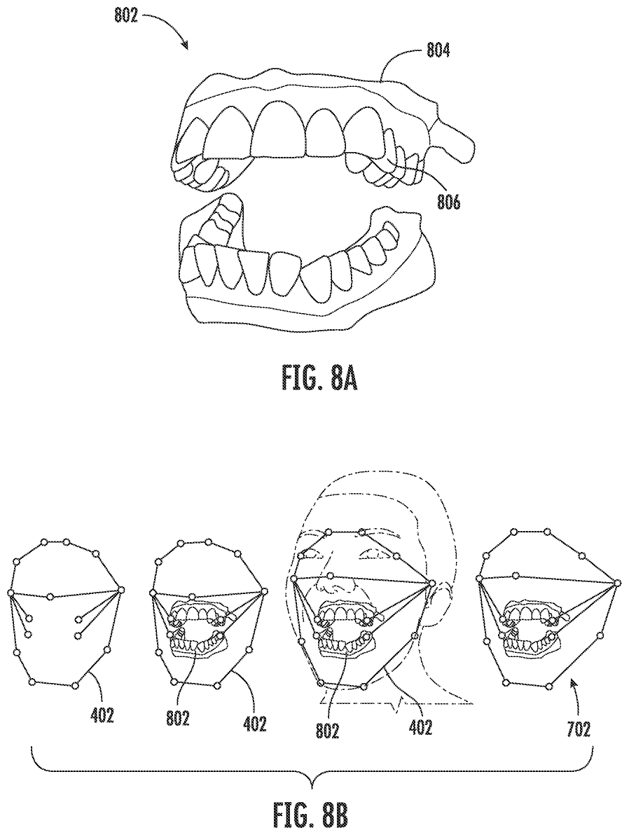

Referring to FIGS. 1, 8A, and 8B, the skeletal modeling computing system 100 may be configured to obtain (e.g., retrieve or receive) a 3D digital model 802 of a dentition of the user. The 3D digital model 802 may be based on data derived from, for example, a scanner, impression kit, or other 2D/3D reconstruction techniques. The 3D digital model 802 may include various data regarding the gingiva 804 and teeth 806. For example, the 3D digital model 802 may include data regarding orientation and alignment of upper and lower teeth 806 as well as surrounding data regarding upper and lower gingiva 804. The 3D digital model 802 may also include data regarding how the upper teeth 806 interact with the lower teeth 806, which can facilitate proper orientation of the upper and lower teeth 806 in the user skeletal model 702. For example, the 3D digital model 802 may include data regarding jaw orientation, positioning, or movement path. The 3D digital model 802 can be oriented relative to the template skeletal model 402 or the user skeletal model 502 based on this data. However, in some embodiments, the 3D digital model 802 may not include data regarding how the upper teeth 806 interact with the lower teeth 806. The skeletal modeling computing system 100 may be configured to match the 3D digital model 802 of the dentition with the template skeletal model 502 or the user skeletal model 702 to facilitate a determination of the actual interaction between the teeth 806 based on a jaw orientation of the user skeletal model 702. For example, the skeletal modeling computing system 100 may be configured to match the 3D digital model 802 of the dentition with the user skeletal model 702 such that the plurality of teeth 806 of the 3D digital model 802 fit within the user skeletal model 702. The user skeletal model 702 with the 3D digital model 802 incorporated therewith can provide data regarding movement paths of the teeth 806 when a mouth of the user is opening and closing. In another example, the skeletal modeling computing system 100 may be configured to match the 3D digital model 802 of the dentition with the template skeletal model 402. The template skeletal model 402 may be adjusted based on a geometry of the 3D digital model 802 by comparing model landmarks 502 of the template skeletal model 402 and corresponding landmarks of the 3D digital model 802 (e.g., teeth 806). The skeletal modeling computing system 100 may be configured to adjust the template skeletal model 402 and the 3D digital model 802 based on a comparison with user landmarks 302.

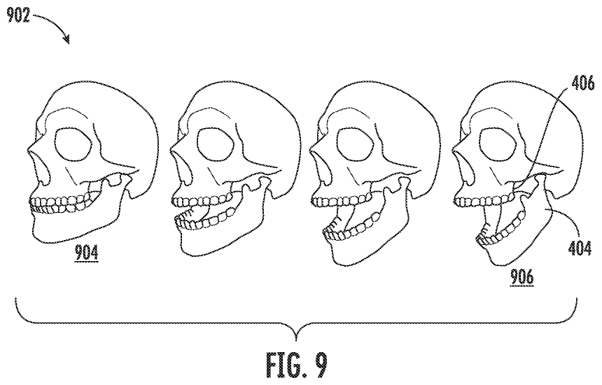

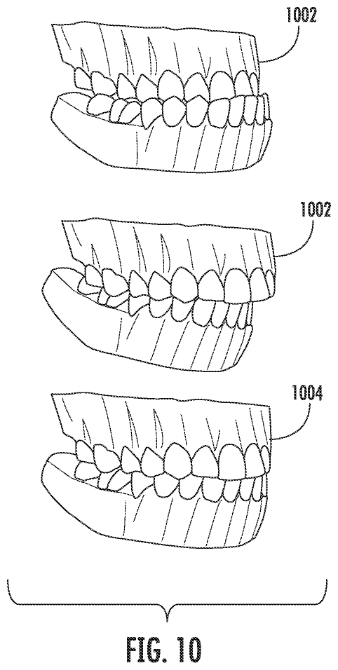

Referring to FIGS. 1 and 9, the skeletal modeling computing system 100 may be configured to simulate a movement of a lower jaw 404 with respect to the upper jaw 406 based on the user skeletal model 702. For example, the simulation processing engine 112 may be configured to simulate the movement of a lower jaw 404 with respect to the upper jaw 406 based on the user skeletal model 702. For example, the simulation processing engine 112 may be configured to provide an animated view 902 of how the jaw bones move relative to each other. The simulation processing engine 112 may accommodate poses of the mouth in any position. For example, the simulation processing engine 112 may generate a simulation including a mouth of the user skeletal model 702 moving between an open position 904 and a closed position 906. This may determine a natural path of movement of the lower jaw 404 relative to the upper jaw 406.

The simulation processing engine 112 may be configured to identify an abnormality regarding the patient's dentition based on the user skeletal model 702. For example, the simulation of the user skeletal model 702 can provide data regarding a user's temporal mandibular joint (TMJ). For example, the simulation can show how the lower jaw 404 moves within the TMJ. The simulation can also provide data regarding undesirable pressure or force that is being applied to the skeletal structure of the user. For example, the dentition of the user may look appropriate when the user's mouth is closed, but the simulation can show if an offset of the jaw is causing unnecessary pressure on the teeth 806 when in the closed position or if the lower jaw 404 has a unique path (e.g., not straight) when traveling between an open and closed position.

In some embodiments, the simulation processing engine 112 may be configured to determine an occlusion status of the user's dentition based on the user skeletal model 702. For example, the simulation processing engine 112 may designate the user skeletal model 702 as having an undesirable occlusal status 1002. The skeletal model 702 may be designated to have an undesirable occlusal status 1002 based on a characteristic of the skeletal model 702 or based on a characteristic of the skeletal model not meeting a threshold requirement. An undesirable occlusal status 1002 may indicate that a bite of the user is offset from a desired orientation. For example, an undesirable occlusal status 1002 may be based on the user having an underbite or an overbite. A desirable or healthy occlusal status 1004 may indicate that the bite of the user has a desired orientation. The determination of the occlusal status may be based on industry standards defining what constitutes an overbite, an underbite, or any other undesirable occlusal orientation. For example, industry standards may indicate that if a top front tooth extends beyond a bottom front tooth more than a predetermined distance, the bite is considered to have an overbite and an undesirable occlusal status 1002. For example, the determination of the occlusal status may be based on the Angle Classification of Malocclusion. The Angle Classification of Malocclusion comprises three classes (Class 1, Class 2, and Class 3). Class 1 indicates a normal occlusion, Class 2 indicates a distoocclusion (e.g., an overbite), and Class 3 indicates a mesioocclusion (e.g., an underbite). The Angle Classification of Malocclusion generally relies on the alignment of the first molars to assign a classification to a jaw. In some embodiments, the simulation processing engine 112 may determine the distance between the top front tooth and the bottom front tooth of the user skeletal model 702 and determine the occlusal status by comparing the distance with the industry threshold. In some embodiments, the simulation processing engine 112 may determine a location and alignment of the first molars of the user skeletal model 702 and determine the occlusal status by comparing the alignment with the Angle Classifications. In another embodiment, the simulation engine 112 may be configured to determine the trajectory and range of motion of the individual landmarks. For example, the simulation engine 112 may determine the range of motion that a user can move their lower jaw 404 relative to their upper jaw 406. The simulation engine 112 may further use the range of motion to determine how wide the user can open their mouth, detect characteristic jaw movements, or provide data regarding a user's temporal mandibular joint (TMJ).

In some embodiments, the simulation processing engine 112 can identify the cause of any abnormality. For example, an undesirable occlusal status 1002 may be based on an orientation of the user's teeth 806. In some embodiments, the undesirable occlusal status 1002 may be based on the skeletal structure of the user's head.

The skeletal modeling computing system 100 may be configured to generate a treatment plan based on the user skeletal model 702. For example, the treatment plan processing engine 114 may be configured to generate a treatment plan based on the user skeletal model. In some embodiments, responsive to a determination of an undesirable occlusal status 1002 or a detection of any other abnormality, the treatment plan processing engine 114 may generate a treatment plan. The treatment plan may be configured to correct or improve the abnormality or to prevent the abnormality from worsening, or it may be configured to move one or more teeth for purely cosmetic reasons. For example, the treatment plan may be based on correcting an undesirable occlusal status 1002. The treatment plan may also be generated to correct an abnormality regarding the movement of the lower jaw 404. For example, the simulation processing engine 112 may identify a non-linear path for the lower jaw 404 when moving between an open and closed position or may identify that a portion of the lower jaw 404 does not remain within the TMJ as it should when moving. The treatment plan may be configured to correct or improve the abnormalities regarding the lower jaw 404 or prevent the abnormalities from worsening. The treatment plan may further be configured to optimize a characteristic 202 of the user such as the facial profile or the alignment of the nose, lips, or other soft tissue features.

The treatment plan may include at least one of a dental approach, a skeletal approach, or a surgical approach. For example, an abnormality may be correctable by reorienting or repositioning the user's teeth 806 such that the treatment plan may take a dental approach and focus on adjusting the teeth 806. In some embodiments, the abnormality may be correctable by adjusting the orientation or positioning of a skeletal feature (e.g., the lower jaw 404). If the user is still growing (e.g., the skeleton of the user is still growing and changing), the treatment plan may focus on adjusting the skeleton of the user via various orthodontic tools or appliances (e.g., head gear, braces, expanders, dental aligners, etc.). If the user is no longer growing (e.g., the skeleton of the user is no longer growing), the treatment plan may resort to surgery to correct the abnormality.

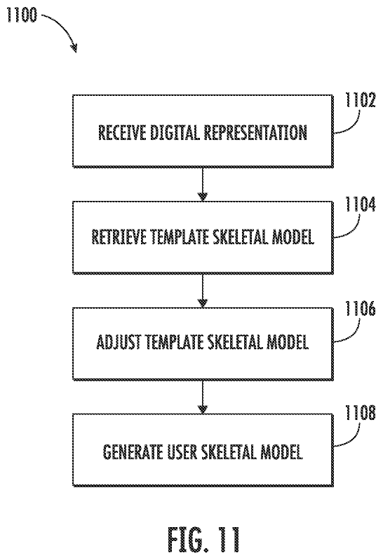

Referring to FIG. 11, a method 1100 of generating a user skeletal model is shown, according to an exemplary embodiment. Method 1100 may include receiving a digital representation of a user (step 1102), retrieving a template skeletal model (step 1104), adjusting the template skeletal model to match a profile of the user (step 1106), and generating a user skeletal model that resembles a skeleton of the user (step 1108).

At step 1102, one or more processors may receive a digital representation 118 of a user. For example, the digital representation processing engine 108 may receive a digital representation 118. The digital representation processing engine 108 may receive a plurality of digital representations 118. For example, the digital representation processing engine 108 may receive a plurality of 2D images. The plurality of 2D images may include images captured from a plurality of different perspectives and images depicting a plurality of different expressions. The plurality of different expressions may include at least one open orientation 904 and at least one closed orientation 906. Step 1102 may include analyzing the digital representations 118. For example, the one or more processors may identify a user landmark 302 from the digital representation 118 or a characteristic 202 of the user.

At step 1104, one or more processors may retrieve a template skeletal model 402. For example, the model processing engine 110 may retrieve a template skeletal model 402. The template skeletal model 402 may include a lower jaw 404 and an upper jaw 406. Retrieving the template skeletal model 402 may include selecting a template skeletal model 402 from a plurality of template skeletal models stored in the template database 106. Selecting the template skeletal model 402 may include identifying a template skeletal model 402 that has a characteristic(s) 202 that corresponds with the identified characteristics 202 from the digital representation 118. For example, if an identified characteristics 202 of the user includes being female, the template skeletal model 402 may correspond to a female. The template skeletal model 402 may be based on at least one of an age, gender, race, or facial feature of the user. If no template skeletal model 402 matches the characteristic identified in the digital representation 118, the one or more processors may select the closest template skeletal model 402 (e.g., a template skeletal model 402 that has a subset of the characteristics), a completely generic template skeletal model 402, or a random template skeletal model 402, for example.

At step 1106, one or more processors may adjust the template skeletal model 402 to match a profile of the user depicted in the digital representation 118. Adjusting the template skeletal model 402 may include identifying a plurality of user landmarks 302 associated with the profile of the user from the digital representations 118. Adjusting the template skeletal model 402 may include identifying a plurality of model landmarks 502 associated with the template skeletal model 402. Each of the plurality of model landmarks 502 may have a corresponding user landmark 302. Adjusting the template skeletal model 402 may include adjusting the plurality of model landmarks 502 to match a position of a respective corresponding user landmark 302. Adjusting the template skeletal model 402 may include iteratively adjusting the template skeletal model 402 based on a plurality of digital representations 118. In some embodiments, step 1106 may include overlaying a projection of the template skeletal model 402 with the digital representation 118 and iteratively adjusting the template skeletal model to match the profile and skeletal features of the user captured in the digital representation 118.

In some embodiments, step 1106 may include receiving a 3D digital model 802 of a dentition of the user. The 3D digital model 802 may include a plurality of teeth 806. Step 1106 may further include matching the 3D digital model 802 of the dentition with the user skeletal model 702 such that the plurality of teeth 806 of the 3D digital model 802 fit within the user skeletal model 702.

At step 1108, one or more processors may generate a user skeletal model 702. For example, the model processing engine 110 may generate a user skeletal model 702. The user skeletal model 702 may resemble a skeleton of the user. The model processing engine 110 may simulate a movement of the lower jaw 404 with respect to the upper jaw 406 based on the user skeletal model 702. Step 1108 may include determining an abnormality of the user's dentition based on the user skeletal model. For example, model processing engine 110 may determine an occlusion status of the user is undesirable. In some embodiments, step 1108 may include generating a treatment plan. The treatment plan may be based on the user skeletal model 702. For example, the treatment plan may be configured to correct or improve the occlusion status.

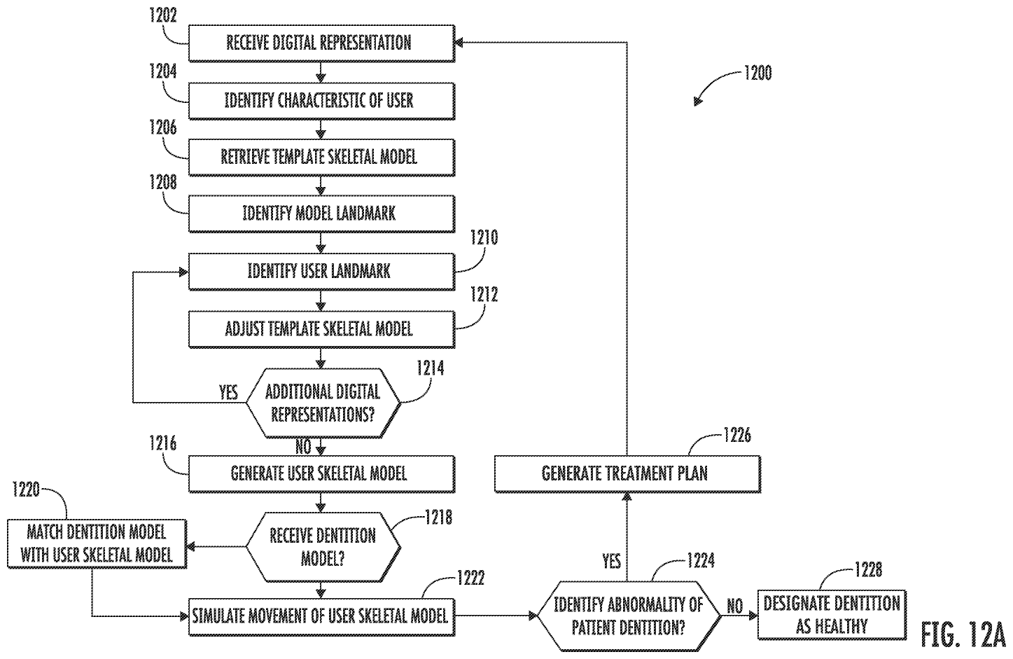

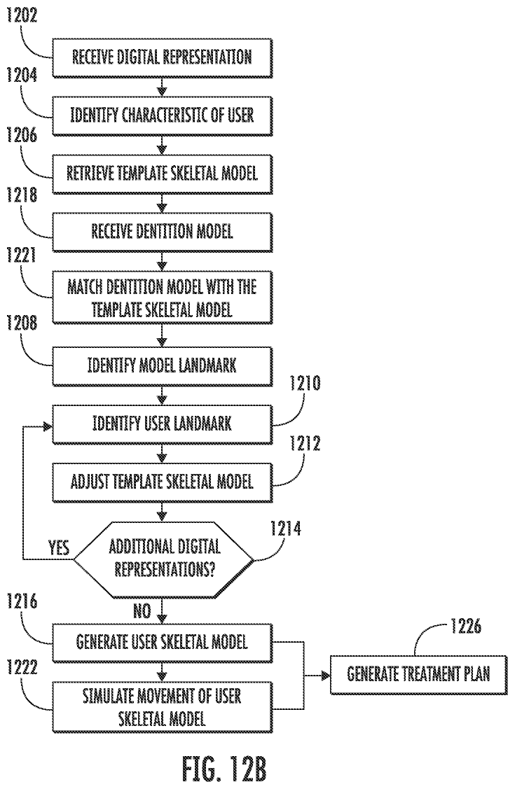

Referring to FIGS. 12A-12B, a method 1200 of generating a user skeletal model is shown, according to exemplary embodiments. Method 1200 may include receiving a digital representation (step 1202), identifying a characteristic of a user (step 1204), retrieving a template skeletal model (step 1206), identifying a model landmark (step 1208), identifying a user landmark (step 1210), adjusting the template skeletal model (step 1212), and determining whether there are additional digital representations to analyze (step 1214). If there are additional digital representations to analyze, method 1200 may return to steps 1210 and 1212 to identify a user landmark in the additional digital representations and adjust the template skeletal model again. If there are no additional digital representations to analyze, method 1200 may include generating a user skeletal model (step 1216) and receiving a dentition model (step 1218). If the system receives a dentition model, method 1200 may include matching the dentition model with the user skeletal model (step 1220). In some embodiments, method 1200 may include matching the dentition model with the template skeletal model (step 1221). If there is no dentition model or after matching the dentition model with the user skeletal model, method 1200 may include simulating movement of the user skeletal model (step 1222) and identifying an abnormality of the patient dentition (step 1224). If an abnormality is identified, method 1200 may include generating a treatment plan (step 1226). If no abnormality is identified, method 1200 may include designating the user's dentition as healthy (step 1228). The embodiment shown in FIG. 12A is for example purposes only and the sequence may be changed. For example, as shown in FIG. 12B, retrieving the template skeletal model (step 1206) may be followed by receiving a 3D digital model 802 of a dentition of the user (step 1218) and matching the 3D digital model of the user 802 with the template skeletal model (step 1221). Adjusting the template skeletal model (step 1212) may thus include adjusting the template skeletal model based on the known geometry of the 3D digital model 802 of a dentition of a user, which is compared to the user landmarks, for example teeth that are visible in the digital representation 118 of the user.

At step 1202, one or more processors may receive a digital representation 118. For example, the digital representation processing engine 108 can receive a digital representation 118. The digital representation processing engine 108 may receive a plurality of digital representations 118. The digital representation 118 may be a 2D image or a video, among others. At step 1204, the one or more processors may identify a characteristic 202 of the user based on the digital representation 118. For example, the digital representation processing engine 108 may identify a characteristic 202. The characteristic 202 may be, for example, an age, gender, race, or facial feature of the user. The digital representation processing engine 108 may analyze (e.g., image recognition, text recognition, etc.) the digital representation 118 to identify the characteristic 202. The digital representation processing engine 108 may identify a plurality of characteristics 202 of the user from the digital representation 118.

At step 1206, the one or more processors may retrieve a template skeletal model 402. For example, the model processing engine 110 may retrieve a template skeletal model 402. The model processing engine 110 may retrieve the template skeletal model 402 from the template database 106. The template skeletal model 402 may be a 3D representation of a skeletal model, a wireframe skeletal model, or a combination of a wireframe model and 3D objects or landmarks. The template database 106 may store a plurality of template skeletal models 402. The model processing engine 110 may select the template skeletal model 402 from the plurality of template skeletal models 402. The model processing engine 110 may select the template skeletal model 402 based on the characteristic 202 identified from the digital representation 118. For example, the template skeletal model 402 may be based on at least one of an age, race, gender, or facial feature of the user. A characteristic 202 of the template skeletal model 402 may be the same characteristic 202 identified form the digital representation 118.

At step 1208, the one or more processors may identify a model landmark 502. For example, the model processing engine 110 may identify a model landmark 502. The model landmark 502 may correspond with a feature of the template skeletal model 402. At step 1210, the one or more processors may identify a user landmark 302. For example, the digital representation processing engine 108 may identify the user landmark 302. The user landmark 302 may correspond with a feature of the user. The model landmark 502 may have a corresponding user landmark 302. For example, a chin model landmark 502a may have a corresponding chin user landmark 302a.

At step 1210, the one or more processors may adjust the template skeletal model 402. For example, the model processing engine 110 may adjust the template skeletal model 402. The template skeletal model 402 may be modified to match or resemble a skeleton of the user. To adjust the template skeletal model 402 the model processing engine 110 may overlay a projection 602 of the template skeletal model 402 (e.g., the model landmarks 502) with the digital representation 118. The model processing engine 110 may compare the model landmarks 502 with the user landmarks 302 and adjust the template skeletal model 402 such that the model landmarks 502 are disposed at the same position as the corresponding user landmark 302. At step 1214, if there are a plurality of digital representations 118, the model processing engine 110 can iteratively adjust the template skeletal model 402 based on the plurality of digital representations 118. For example, method 1200 can repeat steps 1210 and 1212 any number of times.

At step 1216 the one or more processors may generate a user skeletal model 702. For example, the model processing engine 110 may generate a user skeletal model 702. The user skeletal model 702 may represent an actual skeleton of the user. At step 1218 the one or more processors may receive a 3D digital model 802. For example, the model processing engine 110 may receive a 3D digital model 802. The 3D digital model 802 may include a model of the user's dentition, including the gingiva 804 and teeth 806. In some embodiments, the 3D digital model 802 may not include data regarding orientation of an interaction between a lower jaw 404 and an upper jaw 406 of the user.

At step 1220, the model processing engine 110 may match the 3D digital model 802 with the user skeletal model 702. The user skeletal model 702 can provide the placement, orientation, and movement data for the user's dentition that the 3D digital model 802 does not include. The model processing engine 110 may match landmarks of the 3D digital model with landmarks of the user skeletal model 702 to integrate (e.g., align, position, etc.) the 3D digital model with the user skeletal model 702.

Referring to FIG. 12B, at step 1221, the model processing engine 110 may instead match the 3D digital model 802 with the template skeletal model 702. For example, model processing engine 110 may adjust the template skeletal model 402 based on a geometry of the 3D digital model 802 by comparing model landmarks 502 of the template skeletal model 402 and corresponding landmarks of the 3D digital model 802 (e.g., teeth 806). The model processing engine 110 may be configured to adjust the template skeletal model 402 and the 3D digital model 802 based on a comparison with user landmarks 302.

At step 1222 the one or more processors may simulate movement of the user skeletal model 702. For example, the simulation processing engine 112 may simulate movement of the user skeletal model 702. The simulation can include movement of the lower jaw 404 with respect to the upper jaw 406. The simulation can identify how the lower jaw 404 interacts with the upper jaw 406 at the TMJ.

At step 1224 the one or more processors may identify an abnormality of the patient's dentition. For example, the simulation processing engine 112 may identify an abnormality of the patient's dentition. The abnormality may be an undesirable occlusal status 1002. For example, the dentition may have an overbite or an underbite that constitutes an undesirable occlusal status 1002. The abnormality may be a poor interaction between the lower jaw 404 and the upper jaw 406 at the TMJ. If an abnormality is detected, at step 1226 the one or more processors may generate a treatment plan. For example, the treatment plan processing engine 114 may generate the treatment plan. The treatment plan may be designed to correct, improve, or prevent the abnormality. The treatment plan can include at least one of a dental approach, a skeletal approach, or a surgical approach. In some embodiments, generating the treatment plan at step 1226 can be performed prior to or in the absence of simulating movement of the user skeletal model (step 1222). Method 1200 can be repeated to monitor progress of the treatment plan. Method 1200 can be repeated after completion of the treatment plan to assess efficacy of the treatment, identify potential orthodontic relapse, or detect potential unwanted movement or effects of the treatment (e.g., open bite, cross bite, etc.).

At step 1228, if no abnormality is found, the one or more processors may designate the dentition as healthy. For example, treatment plan processing engine 114 may designate the dentition as healthy. Method 1200 may be repeated even without out any abnormalities to continue monitoring of the dentition. For example, a dentition of a user under a predetermined age may still be changing as the user is growing. Method 1200 can continue to monitor the dentition even if no abnormalities are identified.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine” or “circuit” may include hardware and machine-readable media storing instructions thereon for configuring the hardware to execute the functions described herein. The engine or circuit may be embodied as one or more circuitry components including, but not limited to, processing circuitry, network interfaces, peripheral devices, input devices, output devices, sensors, etc. In some embodiments, the engine or circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine or circuit may include any type of component for accomplishing or facilitating achievement of the operations described herein. For example, an engine or circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine or circuit may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines or circuits (e.g., engine A and engine B, or circuit A and circuit B, may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given engine or circuit or components thereof may be disposed locally (e.g., as part of a local server, a local computing system, etc.) or remotely (e.g., as part of a remote server such as a cloud based server). To that end, engines or circuits as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A method comprising:
receiving, by one or more processors, a digital representation of a user, the digital representation comprising at least one of a 2D image or a video;
retrieving, by the one or more processors, a template skeletal model;
adjusting, by the one or more processors, the template skeletal model to match a profile of the user depicted in the digital representation; and
generating, by the one or more processors, a user skeletal model that resembles a skeleton of the user.

2. The method of claim 1, further comprising retrieving, by the one or more processors, the template skeletal model from a template database, wherein the template skeletal model is based on at least one of an age, a gender, a race, or a facial feature of the user.

3. The method of claim 1, further comprising generating, by the one or more processors, a treatment plan based on the user skeletal model.

4. The method of claim 1, further comprising:
receiving, by the one or more processors, a 3D digital model of a dentition of the user, the 3D digital model including a plurality of teeth; and
matching, by the one or more processors, the 3D digital model of the dentition with the user skeletal model such that the plurality of teeth of the 3D digital model fit within the user skeletal model.

5. The method of claim 1, wherein the user skeletal model includes an upper jaw and a lower jaw, the method further comprising simulating, by the one or more processors, movement of the lower jaw with respect to the upper jaw based on the user skeletal model.

6. The method of claim 1, further comprising:
determining, by the one or more processors based on the user skeletal model, an occlusion status of the user; and
generating, by the one or more processors, a treatment plan to adjust the occlusion status.

7. The method of claim 1, wherein adjusting the template skeletal model to match the profile of the user comprises:
identifying, by the one or more processors, a plurality of user landmarks associated with the profile of the user from the digital representation;
identifying, by the one or more processors, a plurality of model landmarks associated with the template skeletal model; and
adjusting, by the one or more processors, the plurality of model landmarks to match a position of a respective corresponding user landmark.

8. The method of claim 1, further comprising receiving, by the one or more processors, a plurality of 2D images, the plurality of 2D images comprising at least one of images captured from a plurality of different perspectives or images depicting a plurality of different expressions, the plurality of different expressions including at least one mouth-open orientation and at least one mouth-closed orientation.

9. The method of claim 1, further comprising:
receiving, by the one or more processors, a plurality of 2D images;
adjusting, iteratively, by the one or more processors, the template skeletal model based on the plurality of 2D images.

10. The method of claim 1, further comprising:
overlaying, by the one or more processors, a projection of the template skeletal model with the digital representation; and
iteratively adjusting, by the one or more processors, the template skeletal model to match the profile and skeletal features of the user captured in the digital representation.

11. A system comprising:
a processor; and
a memory coupled with the processor, wherein the memory is configured to store instructions that, when executed by the processor, cause the processor to:
receive a digital representation of a user, the digital representation comprising at least one of a 2D image or a video;
retrieve a template skeletal model;
adjust the template skeletal model to match a profile of the user depicted in the digital representation; and
generate a user skeletal model that resembles a skeleton of the user.

12. The system of claim 11, wherein the instructions, when executed by the processor, further cause the processor to retrieve the template skeletal model from a template database, wherein the template skeletal model is based on at least one of an age, a gender, a race, or a facial feature of the user.

13. The system of claim 11, wherein the instructions, when executed by the processor, further cause the processor to:
receive a 3D digital model of a dentition of the user, the 3D digital model including a plurality of teeth; and
match the 3D digital model of the dentition with the user skeletal model such that the plurality of teeth of the 3D digital model fit within the user skeletal model.

14. The system of claim 11, wherein the instructions, when executed by the processor, further cause the processor to:
determine, based on the user skeletal model, an occlusion status of the user is undesirable; and
generate a treatment plan to improve the occlusion status.

15. The system of claim 11, wherein the instructions, when executed by the processor, further cause the processor to:
identify a plurality of user landmarks associated with the profile of the user from the digital representation;
identify a plurality of model landmarks associated with the template skeletal model; and
adjust the plurality of model landmarks to match a position of a respective corresponding user landmark.

16. The system of claim 11, wherein the instructions, when executed by the processor, further cause the processor to:
receive a plurality of 2D images;
adjust the template skeletal model based on the plurality of 2D images.

17. The system of claim 11, wherein the instructions, when executed by the processor, further cause the processor to:
overlay a projection of the template skeletal model with the digital representation; and
iteratively adjust the template skeletal model to match the profile and skeletal features of the user captured in the digital representation.

18. A non-transitory computer readable medium storing instructions that, when executed by one or more processors, cause the one or more processors to:
receive a digital representation of a user, the digital representation comprising at least one of a 2D image or a video;
retrieve a template skeletal model;
adjust the template skeletal model to match a profile of the user depicted in the digital representation; and
generate a user skeletal model that resembles a skeleton of the user.

19. The non-transitory computer readable medium of claim 18, wherein the instructions, when executed by the one or more processors, cause the one or more processors to:
identify a plurality of user landmarks associated with the profile of the user from the digital representation;
identify a plurality of model landmarks associated with the template skeletal model; and
adjust the plurality of model landmarks to match a position of a respective corresponding user landmark.

20. The non-transitory computer readable medium of claim 18, wherein the instructions, when executed by the one or more processors, cause the one or more processors to:
overlay a projection of the template skeletal model with the digital representation; and
iteratively adjust the template skeletal model to match the profile and skeletal features of the user captured in the digital representation.
